(19) United States
(12) Patent Application Publication
(10) Pub. No.: US 2025/0351837 A1
(43) Pub. Date: Nov. 20, 2025

(54) CHEESE SUBSTITUTE PRODUCT

(71) Applicant: CARGILL, INCORPORATED, Wayzata, MN (US)

(72) Inventors: Franky Franciscus Antonius HOLLANDER, Ochten (NL); Wouter Marie Georges Monique VAN BENEDEN, Sint-Lievens-Esse (BE)

(21) Appl. No.: 18/863,121

(22) PCT Filed: May 11, 2023
(86) PCT No.: PCT/US2023/021892

§ 371 Date: Nov. 5, 2024

(30) Foreign Application Priority Data
May 11, 2022 (EP) 22172736.5

(51) Int. Cl. A23C 20/02; A23D 7/005

(52) U.S. Cl. CPC A23C 20/02; A23D 7/0053; A23D 7/0056

(57) ABSTRACT

The present invention relates to a cheese substitute product comprising protein and/or carbohydrates, an aqueous solution and a randomly interesterified fat, wherein the fatty acid moiety of the randomly interesterified fat has a content of lauric acid (C12) in a range of from 5 to 20 wt. % and a combined content of palmitic acid (C16) and stearic acid (C18) in a range of from 30 to 55 wt. % on total weight of the fatty acid moiety, and the randomly interesterified fat is present in an amount of from 8 to 40 wt. %, preferably from 18 to 40 wt. % . . . . The present invention also relates to a food product comprising the cheese substitute product and a method for preparing a cheese substitute product.

### CROSS-REFERENCE TO RELATED APPLICATIONS

This application claims the benefit of European Application No. 22172736.5, filed May 11, 2022, U.S. which is incorporated by reference herein in its entirety.

### FIELD OF THE INVENTION

The present invention relates to a cheese substitute product, and more specifically to a plant-based cheese substitute product, comprising a randomly interesterified fat.

### BACKGROUND OF THE INVENTION

Cheese is a complex food product that is traditionally produced from milk of different kinds of animals, as well as other raw materials, using a variety of production and aging operations.

There is now a growing interest from consumers in adopting a more plant-based diet, for health, sustainability and/or ethical reasons. Therefore, many products have already been developed wherein raw materials such as milk fat and/or milk proteins have been partially or completely replaced by plant-based alternatives. However, due to its compositional and structural complexity, it is very difficult to mimic real cheese products using plant-based ingredients.

There is thus a need in the industry for cheese substitute products having improved textural and/or sensorial properties. The present invention provides such a product.

### SUMMARY OF THE INVENTION

The present invention relates to a cheese substitute product comprising protein and/or carbohydrates, an aqueous solution and a randomly interesterified fat, wherein the fatty acid moiety of the randomly interesterified fat has a content of lauric acid (C12) in a range of from 5 to 20 wt. % and a combined content of palmitic acid (C16) and stearic acid (C18) in a range of from 30 to 55 wt. % on total weight of the fatty acid moiety, and the randomly interesterified fat is present in an amount of from 5 to 40 wt. %, preferably from 18 to 40 wt. %.

The present invention also relates to a food product comprising the cheese substitute product.

### DETAILED DESCRIPTION

The present invention relates to a cheese substitute product comprising protein and/or carbohydrates, an aqueous solution and a randomly interesterified fat, wherein the fatty acid moiety of the randomly interesterified fat has a content of lauric acid (C12) in a range of from 5 to 20 wt. % and a combined content of palmitic acid (C16) and stearic acid (C18) in a range of from 30 to 55 wt. % on total weight of the fatty acid moiety, and the randomly interesterified fat is present in an amount of from 5 to 40 wt. %, preferably from 18 to 40 wt. %.

In the present invention, the term “cheese substitute product” encompasses edible products that are designed to mimic traditional cheese in terms of properties such as, but not limited to appearance, texture and/or taste: but wherein constituents including milk fat and/or milk proteins have partly or completely been replaced by ingredients that are not originating from animals.

In a preferred aspect of the invention, the cheese substitute product is a plant-based product, also called a vegan cheese product, wherein substantially all milk constituents have been replaced by ingredients that are not originating from animals. In other words, the plant-based cheese product is a cheese substitute product that does not comprise any ingredient that is originating from animals.

The “cheese substitute product” according to the present invention may be a cheese substitute product of any type. Its texture may range from a soft, semi-soft, medium-hard, semi-hard to a hard texture. Examples of cheese substitute product are, but are not limited to, cheddar-style, parmesan style, feta-style, cream cheese-style, gouda-style, mozzarella-style, or ricotta-style cheese substitute products.

The cheese substitute product of the present invention is comprising a randomly interesterified fat, which is a triglyceride composition wherein the fatty acids that are bound as acyl group in glycerides are randomly distributed over the glycerol backbone of the triglycerides.

The randomly interesterified fat can be obtained by means of a process of chemical or enzymatic interesterification.

A chemical interesterification is performed by using an acidic or basic catalyst, preferably a basic catalyst, such as, but not limited to, sodium methoxide or sodium ethoxide.

An enzymatic interesterification is obtained by means of a lipase enzyme. The lipase will generally be non-selective for the positions on the glyceride backbone in order to achieve the optimum random interesterification. Alternatively, selective lipases may be used, provided that the reaction conditions are such that no significant selectivity is observed, for example by running the reaction for extended periods of time. Suitable lipases include the lipases from Thermomyces lanuginosa, Rhizomucor miehei, Rhizopus delemar and Candida rugosa. Preferably, the lipase is suitable for use with food products.

The randomly interesterified fat may be characterized by the position of the saturated(S) and/or unsaturated (U) fatty acids bound onto the glycerol backbone of the triglycerides of the fat. Typically, the abbreviation S is used to denote a saturated fatty acid residue having 8 to 24 carbon atoms. The abbreviation U denotes an unsaturated fatty acid residue having 8 to 24 carbon atoms. Thus, a triglyceride having saturated fatty acids at the 1- and 3-positions and an unsaturated fatty acid at the 2-position of the glycerol backbone is denoted SUS. Likewise, a triglyceride having 2 saturated fatty acids at the 1- or 3-position and at the 2-position of the glycerol backbone and an unsaturated fatty acid at the remaining 1- or 3-position is denoted SSU.

The ratio of SUS over SSU (SUS/SSU) of a fully randomized triglyceride composition is 0.5, whereas the SUS/SSU ratio of a non-randomized triglyceride is significantly higher than 1.

The triglyceride composition of the randomly interesterified fat is characterized by a ratio of SUS over SSU (SUS/SSU) in a range of from 0.5 to 1.0, from 0.6 to 0.9, or from 0.7 to 0.8.

In one aspect of the invention, the randomly interesterified fat is obtained by means of a chemical interesterification

The randomly interesterified fat of the cheese substitute product of the present invention has a fatty acid moiety having a content of lauric acid (C12) in a range of from 5 to 20 wt. %, from 7 to 18 wt. %, or from 10 to 16 wt. % on total weight of the fatty acid moiety. The fatty acid moiety of the randomly interesterified fat has a combined content of palmitic acid (C16) and stearic acid (C18) in a range of from 30 to 55 wt. %, from 32 to 50 wt. %, or from 35 to 48 wt. % on total weight of the fatty acid moiety.

The C12 fatty acids of the randomly interesterified fat may be sourced from lauric fats. Examples of lauric fat are, but are not limited to, coconut oil, hydrogenated coconut oil, palm kernel oil, fully or partially hydrogenated palm kernel oil, palm kernel stearin, hydrogenated palm kernel stearin, palm kernel olein, fully or partially hydrogenated palm kernel olein, or a mixture of two or more thereof.

The C16 and/or C18 fatty acids of the randomly interesterified fat may be sourced from non-lauric fats such as, but not limited to palm-based oil, cocoa butter, shea butter, shea stearin, shea olein, liquid oils such as sunflower oil, rapeseed oil, cottonseed oil or soy bean oil, or any combination of two or more thereof. The triglycerides may be hydrogenated and/or fractionated. The term “palm-based oil” is an oil selected from the group consisting of a palm oil, palm oil stearin, palm oil super stearin, palm oil olein, palm oil super olein, palm oil mid-fraction and blends of one or more thereof.

Preferably, fatty acid moiety of the randomly interesterified fat has a ratio of C18 over C16 in a range of from 1.0 to 10.0, from 1.1 to 8.0, or from 1.2 to 6.5.

In one aspect of the invention, fatty acid moiety of the randomly interesterified fat has a ratio of C18 over C16 in a range of from 1.0 to 2.5, preferably from 1.0 to 2.0.

Without being bound by any specific theory it has been noticed that such a narrow range more closely to 1.0 provides a better texture, and there is less chance for recrystallisation.

Sources of triglycerides having a suitable content of C18 versus C16 are for example cocoa butter, shea butter, sal, mango kernel, illipe butter, or their stearin or olein fractions, fully hydrogenated sunflower oil, fully hydrogenated rapeseed oil, fully hydrogenated cottonseed oil or fully hydrogenated soybean oil, or any combination of two or more thereof.

Preferably the fatty acids of the randomly interesterified fat are not sourced from palm. Examples of sources of fatty acids from palm are palm oil, palm oil fractions, palm kernel oil, palm kernel oil fractions or any combination of two or more thereof.

Preferably the fatty acids of the randomly interesterified fat are not sourced from hydrogenated fats.

In one aspect of the invention, the fatty acid moiety of the randomly interesterified fat has a combined content of oleic acid (C18.1) and linoleic acid (C18.2) in a range of from 25 to 45 wt. %, from 27 to 43 wt. %, or from 30 to 40 wt. % on total weight of fatty acids.

The randomly interesterified triglyceride may have a melting point in a range of from 35 to 65° C., from 38 to 55° C., or from 40 to 50° C. The melting point can be determined according to the official AOCS method Cc 3-25.

In a preferred aspect of the invention, the randomly interesterified fat has:
A fatty acid moiety having:
   a content of C16+C18 in a range of from 30 to 55 wt. %, from 32 to 50 wt. %, or from 35 to 48 wt. % on total weight of fatty acids, and
   a ratio of C18 to C16 of from 1.0 to 1.5, from 1.1 to 1.4, and
   a content of C12 of from 5 to 20 wt. %, from 7 to 18 wt. %, or from 10 to 16 wt. % on total weight of fatty acids, and
   a content of C18.1+C18.2 bound as acyl group in triglycerides of the randomly interesterified fat in a range of from 25 to 45 wt. %, from 27 to 43 wt. %, or from 30 to 40 wt. % on total weight of fatty acids,
an SUS/SSU ratio in a range of from 0.5 to 1.0, from 0.6 to 0.9, or from 0.7 to 0.8, and wherein the fatty acids from the randomly interesterified fat are not sourced from palm and/or hydrogenated fats.

In a further aspect of the invention, the randomly interesterified fat may be present in the cheese substitute product in an amount of from 10 to 30 wt. %, or from 15 to 20 wt. % on the total weight of the cheese substitute product.

The cheese substitute product may have a total fat content in a range of from 5 to 40 wt. %, from 10 to 35 wt. %, or from 15 to 30 wt. % on the total weight of the cheese substitute product. The total fat content of the cheese substitute product may beyond the randomly interesterified fat further comprise other fats such as, but not limited to, palm oil and palm oil fractions such as palm oil stearin or palm oil olein, cocoa butter, shea butter, shea stearin, shea olein, liquid oils or any combination of two or more thereof.

The term “liquid oil” is defined as triglycerides with a melting point of less than 20° C. (at atmospheric pressure). The liquid oil can be one liquid oil or a blend of more than one liquid oils. In case of a blend of liquid oils, it is understood that the blend of the more than one liquid oil has a melting point of less than 20° C. (at atmospheric pressure).

The “liquid oil” is a vegetable oil.

Examples of vegetable liquid oils are amongst others double fractionated palm olein, cottonseed oil, corn oil, groundnut oil, linseed oil, olive oil, rapeseed oil, rice bran oil, sesame oil, safflower oil, soybean oil, sunflower oil, oil from any variety of oilseeds with increased level of unsaturated fatty acids compared to the original seed variety, such as mid or high oleic sunflower oil. These varieties with increased levels of unsaturated fatty acids can be obtained by natural selection or by genetic modification (GMO). Preferably, the vegetable oil is selected from the group consisting of canola oil, cottonseed oil, corn oil, flaxseed oil, grapeseed oil, groundnut oil, linseed oil, olive oil, peanut oil, rapeseed oil, rice bran oil, sesame oil, safflower oil, soybean oil, sunflower oil, their corresponding high oleic varieties, and mixtures of two or more thereof. More preferably, the vegetable oil is selected from the group consisting of corn oil, rapeseed oil, soy bean oil, sunflower oil, their corresponding high oleic varieties, and mixture of two or more thereof. The high oleic varieties are containing at least 40%, at least 50%, at least 60%, at least 70% and preferably at least 80% oleic acid in respect of the fatty acid profile.

In one aspect of the invention, the liquid oil is selected from the group consisting of rapeseed oil, high oleic rapeseed oil, sunflower oil, high oleic sunflower oil, canola oil, high oleic canola oil, high oleic soybean oil, soybean oil, flaxseed oil, grapeseed oil, olive oil, peanut oil, corn oil, groundnut oil, cottonseed oil and a combination of two or more thereof.

In a further aspect of the invention the liquid oil is selected from sunflower oil, rapeseed oil, cottonseed oil or soy bean oil, hydrogenated liquid oils, or any combination of two or more thereof.

In one aspect of the invention, the cheese substitute product may further comprise a liquid oil in a range up to 20 wt. %, from 3 to 18 wt. %, or from 6 to 15 wt. %, on the total weight of the cheese substitute product.

In another aspect of the invention, the cheese substitute product may comprise a liquid oil in a range up to 50 wt. %, from 10 to 40 wt. %, or from 20 to 30 wt. %, expressed on the total weight of fat in the cheese substitute product.

In a preferred aspect of the invention, the cheese substitute product comprises substantially no oils sourced from palm. Certain consumers prefer food and/or feed products without oils sourced from palm, such as palm oil, palm oil fractions, palm kernel oil, palm kernel oil fractions or a combination of two or more thereof. Therefore, the cheese substitute product according to the present invention can offer an alternative to products based on or containing oils sourced from palm.

In another preferred aspect of the invention, the cheese substitute product comprises substantially no hydrogenated fats.

It has been found that the cheese substitute product according to the present invention, having the randomly interesterified fat, has improved textural and/or sensorial properties compared to existing cheese substitute products that are based on coconut oil and/or liquid oil. The cheese substitute product according to the present invention may have improved properties such as an improved spreadability and creaminess, an improved shredability, reduced brittleness and/or more cohesiveness.

The cheese substitute product of the present invention is comprising an aqueous solution. The aqueous solution may be present in an amount of from 35 to 75 wt. %, from 37 to 72 wt. %, or from 40 to 70 wt. % on total weight of the cheese substitute product. The aqueous solution may be, but not limited to, water, cow's milk, cheep's milk, goat's milk, juices from plants or fruits, or combinations of two or more thereof. Examples of juices of plants or fruits are juice of beetroot, cauliflower, celery, apple, almonds, soybeans (also called soy “milk”), hazelnut, coconut (also called coconut “milk”), carrot, cucumber, and the like. Preferably, the aqueous solution is water, an aqueous solution from a vegetable origin, or a combination thereof. The amount of aqueous solution in the cheese substitute product of the present invention may affect the textural properties of the cheese. A high amount of the aqueous solution may reduce hardness and stiffness and increase meltability of the cheese substitute product.

The cheese substitute product of the present invention is comprising protein and/or carbohydrates. Protein and/or carbohydrates may be present in an amount of from 5 to 40 wt. %, from 7 to 35 wt. %, or from 10 to 30 wt. % on total weigh of the cheese substitute product.

Proteins in the cheese substitute product of the present invention may be from animal origin and/or vegetable origin. Proteins from animal origin are, but are not limited to, milk proteins, such as for example rennet casein, acid casein, sodium or calcium-caseinate, whey protein concentrate or isolate, skim milk powder, milk ultrafiltrate, milk protein concentrate, micellar casein powder, microfiltered milk retentate, or a combination of two or more thereof. Proteins from vegetable origin are, but are not limited to, for example soy bean protein concentrate or isolate, wheat gluten, lupine protein, chickpea protein, pea protein concentrate or isolate, zein, or a combination of two or more thereof. If the cheese substitute product is only based on rennet casein, emulsifying salts are needed as stabilizing agents. Preferably, the cheese substitute product of the present invention is comprising no proteins from animal origin.

Carbohydrates in the cheese substitute product of the present invention may be carrageenans, guar gum, xanthan gum, locust bean gum, gum arabic, basil seed gum, pectin, sodium alginate, gellan, starches in native or modified forms from wheat, maize, rice, potato, corn, tapioca, or a combination of two or more thereof. Preferably, the cheese substitute product of the present invention is comprising no carbohydrates from animal origin.

The cheese substitute product of the present invention may further comprise other ingredients such as, but not limited to, emulsifying salts, acids, flavoring ingredients, coloring agents, preservatives, or combinations of two or more thereof. Emulsifying salts are for example sodium or potassium salts of citrates, phosphates, polyphosphates, pyrophosphate, or a combination of two or more thereof. Examples of acids are lactic acid, acetic acid, citric acid, or a combination of two or more thereof. Preservatives may be among others potassium sorbate, calcium or sodium propionate, nisin, natamycin, phosphates, plant extracts, or a combination of two or more thereof.

The cheese substitute product of the present invention may further comprise functional ingredients such as, but not limited to, vitamins and/or minerals, bioactive compounds, dietary fiber, probiotics, prebiotic, or a combination of two or more thereof. Examples of vitamins and minerals are vitamin A, vitamin D, vitamin E, vitamin C, folic acid, magnesium oxide, zinc oxide, iron, riboflavin, thiamine or combinations of two or more thereof. Bioactive compounds are for example carotenoids, flavonoids, phenolic acids, phytosterols, long-chain polyunsaturated fatty acids, microalgae, plant extracts or combinations of two or more thereof. Probiotics may for example be Lactobacillus, Bifidibacterium spp. Prebiotics may for example be inulin, fructooligosaccharide, konjac glucomannan and the like.

In a specific aspect of aspect of the invention, the cheese substitute product is a cream cheese substitute product. The cream cheese substitute product is a spreadable product.

The cream cheese substitute product according of the present invention is comprising, expressed on total weight of the product:
an aqueous solution in a range of from 50 to 75 wt. %, from 52 to 72 wt. %, or from 55 to 70 wt. %;
protein and/or carbohydrates in a range of from 5 to 25 wt. %, 7 to 22 wt. %, or from 10 to 20 wt. %; and
the randomly interesterified fat in a range of from 8 to 25 wt. %, 10 to 22 wt. %, or from 12 to 20 wt. %.

It has been found that the cream cheese substitute product according to the present invention, having the randomly interesterified fat, has an improved texture compared to existing cream cheese substitute products that are based on coconut oil and/or liquid oil. The cream cheese substitute product according to the present invention may have an improved spreadability and creaminess.

In another specific aspect of aspect of the invention, the cheese substitute product is a hard cheese substitute product. The hard cheese substitute product may be in the form of a block, a slice, shredding, or the like.

The hard cheese substitute product according of the present invention is comprising, expressed on total weight of the product:
an aqueous solution in a range of from 35 to 55 wt. %, from 37 to 52 wt. %, or from 40 to 50 wt. %;
protein and/or carbohydrates in a range of from 18 to 40 wt. %, 20 to 35 wt. %, or from 22 to 30 wt. %; and
the randomly interesterified fat in a range of from 18 to 40 wt. %, 20 to 35 wt. %, or from 22 to 30 wt. %.

It has been found that the hard cheese substitute product according to the present invention, having the randomly interesterified fat, has an improved texture compared to existing hard cheese substitute products that are based on coconut oil and/or liquid oil. The hard cheese substitute product according to the present invention may have an improved shredability, showing less residue on the grater. The hard cheese substitute product may be less brittle and more cohesive.

The present invention also relates to a food product comprising the cheese substitute product.

It relates to a food product comprising the cheese substitute product of the present invention and at least a food ingredient that is different from the cheese substitute product. Examples of food products are, but are not limited to pizza, toast, salad, sandwiches, cheeseburger, lasagne, pasta dishes, sauces, desserts, cheese cake, ready-to-prepare meals.

It relates to a food product comprising the cheese substitute product of the present invention and the food product is selected from pizza, toast, salad, sandwiches, cheeseburger, lasagne, pasta dishes, sauces, desserts, cheese cake, or ready-to-prepare meals

It further relates to a method for preparing a cheese substitute product and the method is comprising the steps of.

Adding to protein carbohydrates, and/or an aqueous solution a randomly interesterified fat,
wherein the fatty acid moiety of the randomly interesterified fat has a content of lauric acid (C12) of less than 5.0 wt. % and a combined content of palmitic acid (C16) and stearic acid (C18) in a range of from 35 to 65 wt. % on total weight of the fatty acid moiety.

In an aspect of the invention, the randomly interesterified fat is added in an amount of from 5 to 40 wt. %, preferably from 18 to 40 wt. %.

It relates to the method wherein the fatty acid moiety of the randomly interesterified fat has a ratio of C18 over C16 in a range of from 1.0 to 2.5, preferably from 1.0 to 2.0.

### CLAUSES

1. A cheese substitute product comprising protein and/or carbohydrates, an aqueous solution and a randomly interesterified fat, wherein the fatty acid moiety of the randomly interesterified fat has a content of lauric acid (C12) in a range of from 5 to 20 wt. % and a combined content of palmitic acid (C16) and stearic acid (C18) in a range of from 30 to 55 wt. % on total weight of the fatty acid moiety, and the randomly interesterified fat is present in an amount of from 5 to 40 wt. %, preferably from 18 to 40 wt. %.
2. The cheese substitute product according to clause 1, wherein the fatty acid moiety of the randomly interesterified fat has a ratio of C18 over C16 in a range of from 1.0 to 10.0.
3. The cheese substitute product according to clause 1 or 2, wherein the fatty acid moiety of the randomly interesterified fat has a ratio of C18 over C16 in a range of from 1.0 to 2.5, preferably from 1.0 to 2.0.
4. The cheese substitute product according to any one of the preceding clauses, wherein the fatty acid moiety of the randomly interesterified fat has a content of oleic acid (C18.1) and linoleic acid (C18.2) in a range of from 30 to 55 wt. % on total weight of the fatty acid moiety.
5. The cheese substitute product according to any one of the preceding clauses, wherein the randomly interesterified fat has an SUS/SSU ratio in a range of from 0.5 to 1.0.
6. The cheese substitute product according to any one of the preceding clauses, and the cheese substitute product comprises no hydrogenated fats.
7. The cheese substitute product according to any one of the preceding clauses, and the cheese substitute product optionally comprises a liquid oil in an amount from 0 to 20 wt %.
8. The cheese substitute product according to clause 8, wherein the fatty acid moiety of the blend of randomly interesterified fat and liquid oil has a ratio of C18 over C16 in a range of from 1.0 to 2.5, preferably from 1.0 to 2.0.
9. The cheese substitute product according to any one of the preceding clauses, and the cheese substitute product comprises the randomly interesterified fat and the fatty acids of the randomly interesterified fat and the optionally liquid oil are not sourced from palm oil or palm kernel oil.
10. The cheese substitute product according to any one of the preceding clauses, and the cheese substitute product is a plant-based product.
11. A cheese substitute product prepared by adding to protein, carbohydrates, and/or an aqueous solution, a randomly interesterified fat and optionally liquid oil, wherein the fatty acid moiety of the randomly interesterified fat has a content of lauric acid (C12) in a range of from 5 to 20 wt. % and a combined content of palmitic acid (C16) and stearic acid (C18) in a range of from 30 to 55 wt. % on total weight of the fatty acid moiety, and the randomly interesterified fat is present in an amount of from 5 to 40 wt. %, preferably from 18 to 40 wt. %.
12. The cheese substitute product according to clause 11, wherein the fatty acid moiety of the randomly interesterified fat has a ratio of C18 over C16 in a range of from 1.0 to 10.0.
13. The cheese substitute product according to clause 11 or 12, wherein the fatty acid moiety of the randomly interesterified fat has a ratio of C18 over C16 in a range of from 1.0 to 2.5, preferably from 1.0 to 2.0.
14. The cheese substitute product according to clause 11 or 12, wherein the fatty acid moiety of the blend of randomly interesterified fat and optionally liquid oil has a ratio of C18 over C16 in a range of from 1.0 to 2.5, preferably from 1.0 to 2.0.
15. The cheese substitute product according to any one of clauses 11 to 14, wherein the fatty acid moiety of the randomly interesterified fat has a content of oleic acid (C18.1) and linoleic acid (C18.2) in a range of from 30 to 55 wt. % on total weight of the fatty acid moiety.
16. The cheese substitute product according to any one of clauses 11 to 15, wherein the randomly interesterified fat has an SUS/SSU ratio in a range of from 0.5 to 1.0.
17. The cheese substitute product according to any one of clauses 11 to 16, and the cheese substitute product comprises no hydrogenated fats.
18. The cheese substitute product according to any one of clauses 11 to 17, and the cheese substitute product comprises the randomly interesterified fat and the fatty acids of the randomly interesterified fat are not sourced from palm oil or palm kernel oil.
19. The cheese substitute product according to any one of clauses 11 to 18, and the cheese substitute product is a plant-based product.
20. The cheese substitute product according to any one of clauses 11 to 19 wherein the optionally liquid oil is selected from palm oil, palm oil stearin or palm oil olein, cocoa butter, shea butter, shea stearin, shea olein, sunflower oil, rapeseed oil, cottonseed oil or soybean oil, hydrogenated liquid oils, and any combination of two or more thereof.
21. The cheese substitute product according to any one of clauses 11 to 20 wherein the liquid oil is present in the cheese substitute product in an amount of up to 20 wt. %, from 3 to 18 wt. %, or from 6 to 15 wt. %, on the total weight of the cheese substitute product.
22. A cheese substitute product comprising protein and/or carbohydrates, an aqueous solution and a fat composition, wherein the fat composition is consisting of randomly interesterified fat and optionally a liquid oil, and wherein the fatty acid moiety of the randomly interesterified fat has a a content of lauric acid (C12) in a range of from 5 to 20 wt. % and a combined content of palmitic acid (C16) and stearic acid (C18) in a range of from 30 to 55 wt. % on total weight of the fatty acid moiety, and the randomly interesterified fat is present in an amount of from 5 to 40 wt. %, preferably from 18 to 40 wt. %.
23. The cheese substitute product according to any one of the preceding clauses, comprising, expressed on total weight of the product:
   an aqueous solution in a range of from 35 to 55 wt. %, from 37 to 52 wt. %, or from 40 to 50 wt. %;
   protein and/or carbohydrates in a range of from 18 to 40 wt. %, from 20 to 35 wt. %, or from 22 to 30 wt. %; and
   the randomly interesterified fat in a range of from 18 to 40 wt. %, from 20 to 35 wt. %, or from 22 to 30 wt. %.
24. The cheese substitute product according to clause 23, and the cheese substitute product is in the form of a block, a slice or shredding.
25. The cheese substitute product according to any one of clauses 1 to 22, comprising, expressed on total weight of the product:
   an aqueous solution in a range of from 50 to 75 wt. %, from 52 to 72 wt. % or from 55 to 70 wt. %;
   protein and/or carbohydrates in a range of from 5 to 25 wt. %, from 7 to 22 wt. %, or from 10 to 20 wt. %; and
   the randomly interesterified fat in a range of from 8 to 25 wt. %, from 10 to 22 wt. %, or from 12 to 20 wt. %.
26. The cheese substitute product according to clause 25, and the cheese substitute product is spreadable.
27. A food product comprising the cheese substitute product according to any one of the preceding clauses and at least a food ingredient that is different from the cheese substitute product.
28. A food product comprising the cheese substitute product according to any one of clauses 1 to 26 and the food product is selected from pizza, toast, salad, sandwiches, cheeseburger, lasagne, pasta dishes, sauces, desserts, cheese cake, or ready-to-prepare meals.
29. A method for preparing a cheese substitute product and the method is comprising the steps of
   Adding to protein carbohydrates, and/or an aqueous solution a randomly interesterified fat, and optionally liquid oil,
   wherein the fatty acid moiety of the randomly interesterified fat has a content of lauric acid (C12) in a range of from 5 to 20 wt. % and a combined content of palmitic acid (C16) and stearic acid (C18) in a range of from 30 to 55 wt. % on total weight of the fatty acid moiety.
30. The method of clause 29 wherein the randomly interesterified fat is added in an amount of from 5 to 40 wt. %, preferably from 18 to 40 wt. %.
31. The method according to any one of clauses 29 to 30, wherein optionally a liquid oil is added in an amount from 0 to 20 wt %.
32. The method according to any one of clauses 29 to 31, wherein the fatty acid moiety of the randomly interesterified fat has a ratio of C18 over C16 in a range of from 1.0 to 10.0.
33. The method according to any one of clauses 29 to 32, wherein the fatty acid moiety of the randomly interesterified fat and the optionally liquid oil has a ratio of C18 over C16 in a range of from 1.0 to 2.5, preferably from 1.0 to 2.0.
34. The method according to any one of clauses 29 to 33, wherein the fatty acid moiety of the blend of randomly interesterified fat and optionally liquid oil has a ratio of C18 over C16 in a range of from 1.0 to 2.5, preferably from 1.0 to 2.0.

### Examples

### 1. The Randomly Interesterified Fat

Randomly interesterified fats N° 1 to 3 are obtained by chemically interesterifying the fat blends 1 to 3 as described in table 1. The chemical interesterification is a process that is generally well known by the person skilled in the art.

The fatty acid composition of the randomly interesterified fats are shown in table 1.

TABLE 1
Composition of the fat blends & fatty acid composition
of the randomly interesterified fats

| | | |
|---|---|---|
| No 1 | No 2 | No 3 |

Composition of the fat blends

| | | | |
|---|---|---|---|
| Cocoa butter | | 70 | |
| Shea Butter | | | 75 |
| Coconut oil | 12 | 30 | 25 |
| Fully | 41 | | |
| hydrogenated | | | |
| sunflower oil | | | |
| Sunflower oil | 47 | | |

Fatty acid composition of the randomly
interesterified fats

| | | | |
|---|---|---|---|
| C12 | 5.7% | 14.1% | 11.7% |
| C16 | 7.1% | 20.7% | 5.2% |
| C18 | 39.7% | 26.8% | 32.8% |
| C16 + C18 | 46.8% | 47.5% | 38.0% |
| C18/C16 | 5.6 | 1.3 | 6.3 |
| C18.1 | 13.5% | 25.0% | 34.7% |
| C18.2 | 28.5% | 2.3% | 5.9% |
| C18.1 + C18.2 | 42.0% | 27.3% | 40.6% |

Positional triglyceride composition of the
randomly interesterified fats

| | | | |
|---|---|---|---|
| SUS/SSU | 0.5 | 0.5 | 0.5 |

### 2. Recipe of the Cheese Substitute Product

The recipe of the cheese substitute product is shown in table 2.

TABLE 2
Recipe of the cheese substitute product composition

| | Recipe A | | Recipe B | |
|---|---|---|---|---|
| Rapeseed oil | | | 11 | wt. % |
| Randomly interesterified fat No1 | 22 | wt. % | 11 | wt. % |
| Ratio C18/C16 | 1.3 | | 1.0-1.3* | |
| Lygomme ACH 864K (%)** | 23 | wt. % | 23 | wt. % |
| Salt (%) | 1.5 | wt. % | 1.5 | wt. % |
| Water (%) | 53.5 | wt. % | 53.5 | wt. % |

| | | |
|---|---|---|
| Citric acid | for pH adjustment | for pH adjustment |

*Rapeseed oil has a content of C16 of 2.5-7%, and C18 of 0.8-3 wt %.
**Lygomme ACH 864K (Cargill) is a multiple ingredient system consisting of native starch, modified starch, guar, and carrageenan.

### 3. Preparation of the Cheese Substitute Product

The following steps were taken to prepare the cheese substitute products:
Dry ingredients were mixed with the oil at 65° C. in a Stephan mixer.
Water was added while mixing.
The pH of the mixture was adjusted to pH 4.5 by addition of citric acid.
The mixture was heated up to 85° C. while mixing and the mixture was kept at 85° C. for 3 minutes.
The mixture was cooled down in an ice water bath and a solidified cheese substitute product was obtained.
The cheese substitute product was stored cool, i.e. between 4 and 7° C.

### 4. Evaluation of the Cheese Substitute Product

Evaluation of the cheese substitute products was performed after 14 days of cooled storage.
Texture evaluation:
Texture was measured using a TAXT2i texture analyser and a P/75 compression plate probe with 75 mm diameter. Texture of the cheese substitute products was measured at 5° C. Texture measurements were performed on a cylindrical shaped sample of a cheese substitute product with diameter 20 mm and height 22 mm. The hardness of the cheese substitute products (expressed in grams) was measured as the force necessary to attain a deformation by the probe to 75% of its initial height. Results are shown in table 3.
Processability evaluation:
50 g of cheese substitute product was shredded using a cheese grater. The obtained cheese strands are visually assessed, as well as the grater surface. The shredded cheese substitute product is subsequently sieved over a sieve with a pore size of 2 mm. The percentage of fines is the percentage of shredded pieces that pass the sieve and is calculated as follows:

$$x = 100 \% - ( \frac{100 \% * weight of cheese after sieving [ g ]}{weight of cheese before sieving [ g ]} )$$

Results of the processability evaluation are shown in table 3.

TABLE 3
Results of texture and processing evaluation of cheese
substitute products after cooled storage for 7 days

Recipe A

Texture evaluation

| | |
|---|---|
| Hardness | 5274.3 g |

Processability evaluation

| | |
|---|---|
| Grater | Some presence of fat on the |
| | surface, some visual |
| | residues |
| Visual assessment | No presence of |
| | agglomerations; Gummy, |
| | smooth long strands. |
| % Fines | 0.79% |

1. A cheese substitute product comprising protein and/or carbohydrates, an aqueous solution and a randomly interesterified fat, wherein the fatty acid moiety of the randomly interesterified fat has a content of lauric acid (C12) in a range of from 5 to 20 wt. % and a combined content of palmitic acid (C16) and stearic acid (C18) in a range of from 30 to 55 wt. % on total weight of the fatty acid moiety, and the randomly interesterified fat is present in an amount of from 5 to 40 wt. %, preferably from 18 to 40 wt. %.

2. The cheese substitute product according to claim 1, wherein the fatty acid moiety of the randomly interesterified fat has a ratio of C18 over C16 in a range of from 1.0 to 10.0.

3. The cheese substitute product according to claim 1, wherein the fatty acid moiety of the randomly interesterified fat has a content of oleic acid (C18.1) and linoleic acid (C18.2) in a range of from 30 to 55 wt. % on total weight of the fatty acid moiety.

4. The cheese substitute product according to claim 1, wherein the randomly interesterified fat has an SUS/SSU ratio in a range of from 0.5 to 1.0.

5. The cheese substitute product according to claim 1, and the cheese substitute product comprises no hydrogenated fats.

6. The cheese substitute product according to claim 1, and the cheese substitute product is a plant-based product.

7. The cheese substitute product according to claim 1, comprising, expressed on total weight of the product:
an aqueous solution in a range of from 35 to 55 wt. %, from 37 to 52 wt. %, or from 40 to 50 wt. %;
protein and/or carbohydrates in a range of from 18 to 40 wt. %, from 20 to 35 wt. %, or from 22 to 30 wt. %; and
the randomly interesterified fat in a range of from 18 to 40 wt. %, from 20 to 35 wt. %, or from 22 to 30 wt. %.

8. The cheese substitute product according to claim 7, and the cheese substitute product is in the form of a block, a slice or shredding.

9. The cheese substitute product according to claim 1, comprising, expressed on total weight of the product:
an aqueous solution in a range of from 50 to 75 wt. %, from 52 to 72 wt. % or from 55 to 70 wt. %;
protein and/or carbohydrates in a range of from 5 to 25 wt. %, from 7 to 22 wt. %, or from 10 to 20 wt. %; and
the randomly interesterified fat in a range of from 8 to 25 wt. %, from 10 to 22 wt. %, or from 12 to 20 wt. %.

10. The cheese substitute product according to claim 9, and the cheese substitute product is spreadable.

11. A food product comprising the cheese substitute product according to claim 1, and the food product is selected from pizza, toast, salad, sandwiches, cheeseburger, lasagne, pasta dishes, sauces, desserts, cheese cake, or ready-to-prepare meals.

12. A method for preparing a cheese substitute product and the method is comprising the steps of
Adding to protein carbohydrates, and/or an aqueous solution a randomly interesterified fat, and optionally liquid oil
wherein the fatty acid moiety of the randomly interesterified fat has a content of lauric acid (C12) in a range of from 5 to 20 wt. % and a combined content of palmitic acid (C16) and stearic acid (C18) in a range of from 30 to 55 wt. % on total weight of the fatty acid moiety.

13. The method according to claim 12 wherein the randomly interesterified fat is added in an amount of from 5 to 40 wt. %, preferably from 18 to 40 wt. %.

14. The method according to claim 12, wherein optionally a liquid oil is added in an amount from 0 to 20 wt %.

15. The method according to claim 12, wherein the fatty acid moiety of the randomly interesterified fat and optionally liquid oil has a ratio of C18 over C16 in a range of from 1.0 to 2.5, preferably from 1.0 to 2.0.
